(19) United States
(12) Patent Application Publication
(10) Pub. No.: US 2014/0324644 A1
(43) Pub. Date: Oct. 30, 2014

(54) USING ONLINE PROFESSIONAL NETWORKS TO FACILITATE EXPENSE MANAGEMENT

(71) Applicant: LinkedIn Corporation, Mountain View, CA (US)

(72) Inventor: Matthew Shoup, Mountain View, CA (US)

(21) Appl. No.: 13/870,731

(22) Filed: Apr. 25, 2013

(51) Int. Cl. G06Q 40/00

(52) U.S. Cl. CPC G06Q 40/12
USPC 705/30

(57) ABSTRACT

The disclosed embodiments provide a system that facilitates expense management. The system includes a reporting apparatus that obtains an image of a receipt for an expense of a user. Next, the reporting apparatus enables, for the user, entering of expense data for the expense using information from an online professional network associated with the user. Finally, the reporting apparatus uses the image and the expense data to generate an expense report containing a set of images of receipts for expenses of the user and a set of expense data for the expenses.

### BACKGROUND

1. Field

The disclosed embodiments relate to expense management. More specifically, the disclosed embodiments relate to techniques for using online professional networks to facilitate expense management.

2. Related Art

Employees of an organization commonly submit expense reports containing business expenses incurred during activities related to the operation of the organization. For example, the expense report may include business expenses related to travel, education, team-building activities, and/or client development. The expense reports may then be reviewed by a financial entity within the organization for processing, payment, and/or auditing of the expenses.

However, conventional expense reporting and management is typically associated with significant expenditure of time and manual effort. For example, a client-facing employee of the organization may be required to fill out a form, spreadsheet, and/or other physical and/or digital expense report containing expenses related to travel, lodging, meals, and/or entertainment incurred during a business trip taken by the employee. Next, the employee may submit the expense report, along with scanned and/or physical copies of receipts for the expenses, to the organization for reimbursement. A manager and/or accounting department of the employee may then review the expense report to verify that the expenses comply with the organization's policies for employee expenses and/or external rules and regulations. After the expenses have been reviewed, processed, and/or approved, the manager and/or accounting department may issue a check reimbursing the employee for the expenses several weeks after the expenses were originally incurred.

Consequently, expense management may be facilitated by mechanisms for reducing the overhead associated with reporting, reviewing, and/or reimbursing expenses.

### BRIEF DESCRIPTION OF THE FIGURES

FIG. 1 shows a schematic of a system in accordance with the disclosed embodiments.

FIG. 2 shows a system for facilitating expense management in accordance with the disclosed embodiments.

FIG. 3A shows an exemplary screenshot in accordance with the disclosed embodiments.

FIG. 3B shows an exemplary screenshot in accordance with the disclosed embodiments.

FIG. 3C shows an exemplary screenshot in accordance with the disclosed embodiments.

FIG. 4 shows a flowchart illustrating the process of generating an expense report in accordance with the disclosed embodiments.

FIG. 5 shows a flowchart illustrating the process of facilitating expense management in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

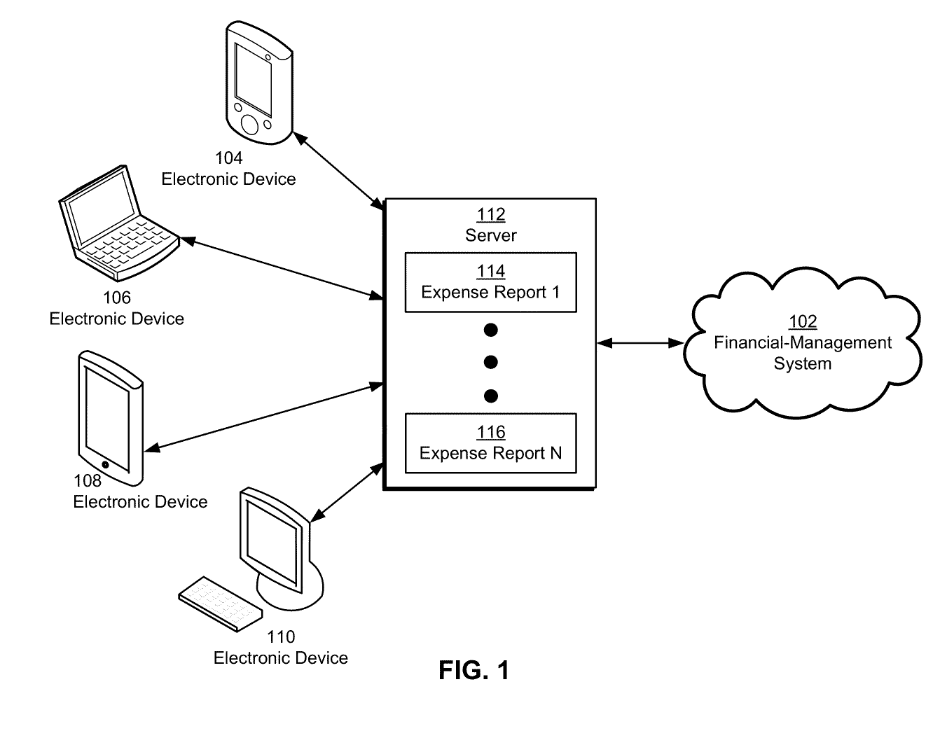

The disclosed embodiments provide a method and system for facilitating expense management. As shown in FIG. 1, a set of expense reports (e.g., expense report 1 114, expense report n 116) may be submitted by employees and/or members of an organization. Each expense report may contain copies of receipts for a set of expenses, as well as expense data describing locations, dates, amounts, and/or other information related to reporting of the expenses. The expense reports may then be provided to a financial-management system 102 for processing, review, auditing, approval, and/or reimbursement of the expenses by managers and/or an accounting department of the organization.

Those skilled in the art will appreciate that the process of creating, submitting, reviewing, and/or processing expense reports may be tedious, time-consuming, and/or inefficient. For example, a user within the organization may create an expense report by filling in a form and/or spreadsheet with expense data for the expenses, scanning receipts of the expenses, and submitting the expense data and scanned receipts to financial-management system 102. Alternatively, the user may send (e.g., mail) physical copies of the form and/or spreadsheet and receipts to a location (e.g., address) associated with financial-management system 102 and/or processing of the expense report. A reviewer of the expense report may then access the expense report through financial-management system 102 and review individual expenses for compliance with internal policy and/or external regulations before approving and/or reimbursing the expenses. In addition, the amount of work associated with performing expense management in the organization may increase with the number of expenses and/or expense reports to be submitted and/or reviewed.

In one or more embodiments, the system of FIG. 1 includes functionality to streamline the generation, processing, and/or review of expense reports. More specifically, expense reports may be created using electronic devices 104-110 and submitted to a server 112 that aggregates and/or stores the expense reports before transmitting the expense reports to financial-management system 102.

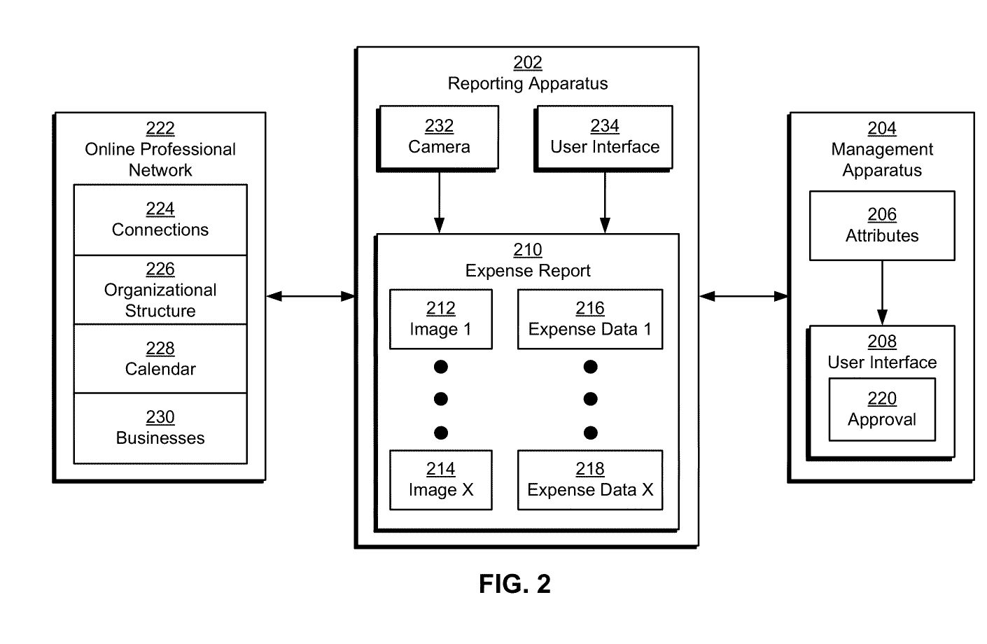

Each electronic device 104-110 may be a personal computer, laptop computer, mobile phone, tablet computer, portable media player, and/or other network-enabled electronic device that is easily transported and/or capable of capturing and/or storing digital media. For example, the electronic device may include a platform-specific application that allows a user to capture images of receipts for expenses using a camera on the electronic device and/or transfer images from the camera to the electronic device. The application may also allow the user to enter expense data for each expense using information from an online professional network associated with the user. As described in further detail below with respect to FIG. 2, the information may include a set of connections of the user, an organizational structure of an employer of the user, a calendar of the user, and/or a set of businesses in proximity to the user.

Server 112 may act as an intermediary between electronic devices 104-110 and financial-management system 102. For example, server 112 may provide an interface with electronic devices 104-110 that enables the transfer of expense data, images of receipts, and/or expense reports from electronic devices 104-110 to server 112. Server 112 may then use a separate interface with financial-management system 102 to transmit expense reports to financial-management system 102 for review, approval, and/or reimbursement of the associated expenses. In other words, server 112 may allow images and/or data related to expenses to be created and/or entered on electronic devices 104-110 and transmitted to financial-management system 102 in the absence of an interface between electronic devices 104-110 and financial-management system 102. Conversely, server 112 may be omitted if an interface between electronic devices 104-110 and financial-management system 102 exists.

After expense reports are received at server 112 and/or financial-management system 102, the expense reports may be provided to reviewers of the expense reports for processing, auditing, approval, and/or reimbursement of the expenses. In addition, review of the expense reports may be facilitated by organizing the provided images and expense data by one or more attributes of the expense data. Facilitating the creation and review of expense reports is discussed in further detail below with respect to FIG. 2.

FIG. 2 shows a system for facilitating expense management in accordance with the disclosed embodiments. As mentioned above, the system of FIG. 2 may facilitate the creation, processing, and/or review of an expense report 210, which contains a set of images (e.g., image 1 212, image x 214) of receipts for expenses of a user and a set of expense data (e.g., expense data 1 216, expense data x 218) for the expenses.

In particular, a reporting apparatus 202 may obtain the images from a camera 232. For example, reporting apparatus 202 may reside on a portable electronic device of the user, such as a mobile phone, tablet computer, and/or portable media player, and capture digital images of the receipts using a built-in camera on the portable electronic device. Alternatively, reporting apparatus 202 may obtain previously captured images from storage on the portable electronic device and/or capture the images using an external camera and transfer the images to storage on the portable electronic device.

Similarly, reporting apparatus 202 may obtain the expense data through a user interface 234 with the user. Continuing with the above example, reporting apparatus 202 may interact with the user through one or more input/output (I/O) devices of the portable electronic device, including a display, keyboard, touchscreen, microphone, and/or speaker. To enable entry of the expense data, reporting apparatus 202 may provide one or more form fields, drop-down menus, radio buttons, checkboxes, and/or other user-interface elements within a graphical user interface (GUI) and/or other type of user interface 234 supported by the I/O device(s).

In one or more embodiments, the expense data obtained by reporting apparatus 202 includes information related to reporting of the expense. For example, the user may provide a name and/or description of the expense and group the expense with a set of related expenses incurred during a trip, event, activity, and/or time period. The user may also identify the type of the expense as lodging, business, entertainment, education, relocation, and/or another accounting-related category. Finally, the user may specify a location and/or date at which the expense was incurred, one or more participants (e.g., coworkers, clients, etc.) in the expense, and/or an amount of the expense.

One or more data elements of the expense data may also be obtained from metadata for the image of the expense's receipt. For example, the image may be obtained and/or stored with exchangeable image file format (EXIF) data that includes location information, timestamps, and/or other data that may be used as expense data and/or to verify expense data entered by the user.

To facilitate the creation of expense report 210, reporting apparatus 202 may enable entering of expense data for each expense using information from an online professional network 222 associated with the user.

For example, reporting apparatus 202 may include an interface with online professional network 222 that allows user-interface elements in user interface 234 to be populated and/or auto-completed using information from online professional network 222.

As shown in FIG. 2, the information may include a set of connections 224 of the user, such as coworkers, business associates, friends, acquaintances, and/or family. As a result, connections 224 may be used to facilitate the identification of participants in an expense. The information may also include an organizational structure 226 of the user's employer, such as the business and/or organization with which the user is employed. Like connections 224, organizational structure 226 may be used to identify and/or filter potential participants in an expense. Organizational structure 226 may also be used to identify and/or locate reviewers of expense report 210, including the user's manager and/or one or more members of an accounting department of the employer.

The information may also include a calendar 228 of the user. Calendar 228 may include scheduled events that may be expensed and/or related to the user's expenses. For example, calendar 228 may include a meeting with a set of participants that may be imported into expense data for an expensed lunch following the meeting. Finally, the information may include a set of businesses 230 in proximity to the expense. Continuing with the previous example, the geolocation of the meeting and/or expensed lunch may be used to identify a set of nearby restaurants and/or menus of the restaurants to allow the user to select specific restaurants and/or menu items associated with the expensed lunch.

Information from online professional network 222 and/or reporting apparatus 202 may additionally be combined to further facilitate the entering of expense data through user interface 234. For example, previous expense reports of the user may be analyzed to determine patterns and/or recurring expenses of the user. If the user enters an expense at a location, date, and/or time that is related to the patterns and/or recurring expenses, one or more elements of expense data for the expense may be suggested to the user and/or auto-completed for the user, and the user may be prompted to verify the suggested and/or auto-completed elements.

After a set of images and/or expense data for expenses are obtained by reporting apparatus 202, reporting apparatus 202 may aggregate the images and expense data into expense report 210 for the user and transmit expense report 210 to a management apparatus 204 such as financial-management system 102 of FIG. 1 and/or another mechanism for reviewing, processing, auditing, and/or otherwise managing expenses. Management apparatus 204 may then provide the images and expense data to a reviewer of the expense report through a separate user interface 208. For example, management apparatus 204 may display the images and/or expense data to the reviewer through a GUI, web-based user interface, and/or a user interface of an application on an electronic device of the reviewer.

Management apparatus 204 may also facilitate review of the expense report by organizing the provided images and expense data by one or more attributes 206 of the expense data. This can help out greatly during the auditing process, and can also simplify the task of managing the auditing process. First, management apparatus 204 may color-code the images and/or expense data based on expense type, amount, date, location, and/or other data elements of the expense data. (Note that this color coding can significantly reduce human errors during the process of reviewing expense reports.) Second, management apparatus 204 may sort the images and/or expense data by attributes 206. For example, management apparatus 204 may display the images and/or line items representing expenses to the reviewer and allow the reviewer to sort the images and/or line items by expense group, expense type, amount, date, location, and/or participants. Management apparatus 204 may also overlay the images and/or line items with colors that represent different expense groups, expense types, amounts, dates, locations, and/or participants.

Management apparatus 204 may further enable approval 220 of individual expenses from expense report 210 by the reviewer. For example, management apparatus 204 may allow the reviewer to select and view images and/or expense data for individual expenses and approve the expenses for reimbursement through user interface 208.

Consequently, the system of FIG. 2 may streamline the creation, review, and/or processing of expense report 210. In particular, reporting apparatus 202 may allow the user to provide copies of receipts for expenses using a built-in camera 232 on a portable electronic device instead of mailing physical copies of the receipts and/or scanning the receipts before adding the scanned receipts to expense report 210. In addition, information from online professional network 222 may expedite the entry of expense data through user interface 234, as well as the delivery of expense report 210 to one or more reviewers of expense report 210. Finally, management apparatus 204 may allow a reviewer of expense report 210 to easily identify, locate, and/or approve individual expenses within expense report 210.

Those skilled in the art will appreciate that the system of FIG. 2 may be implemented in a variety of ways. As described above, reporting apparatus 202 may be provided by an electronic device of the user. Alternatively, a portion of reporting apparatus 202 may be provided by one or more servers, such as server 112 of FIG. 1. Similarly, management apparatus 204 may be accessed through a separate electronic device and/or one or more servers. In other words, reporting apparatus 202 and management apparatus 204 may be implemented together and/or separately by one or more hardware and/or software components and/or layers.

Second, interaction between reporting apparatus 202, management apparatus 204, and/or online professional network 222 may involve a number of techniques for transmitting and/or structuring data. For example, information from online professional network 222 and/or expense data in expense report 210 may be transmitted and/or stored within Portable Document Format (PDF) documents, spreadsheets, web pages, Extensible Markup Language (XML) documents, JavaScript Object Notation (JSON) objects, and/or other types of structured documents and/or data. Expense report 210 may then be stored within a relational database and/or flat file database by management apparatus 204 for subsequent access and/or processing by one or more reviewers.

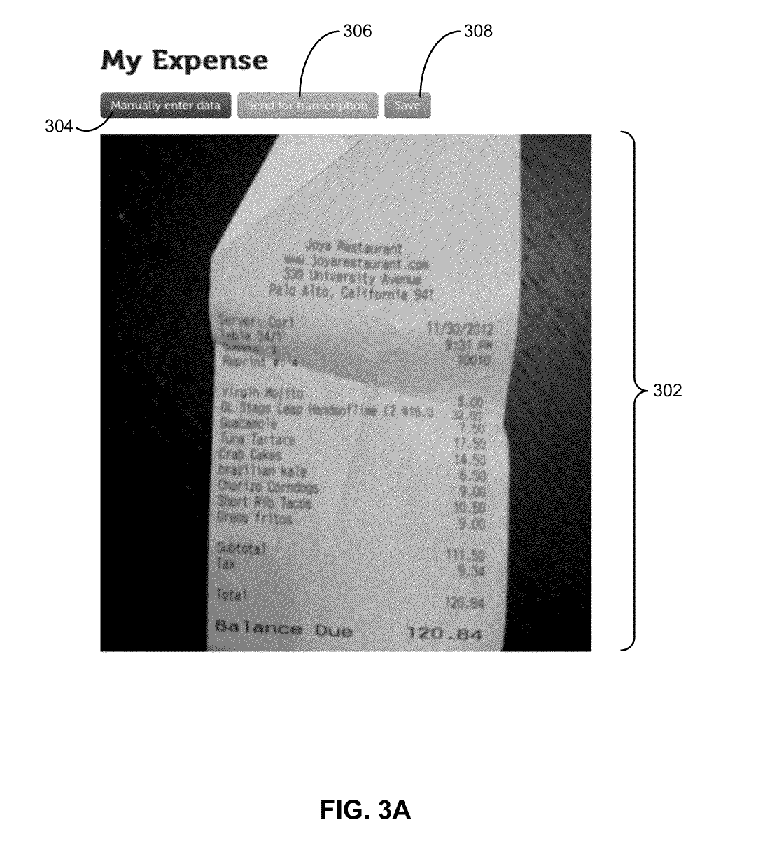

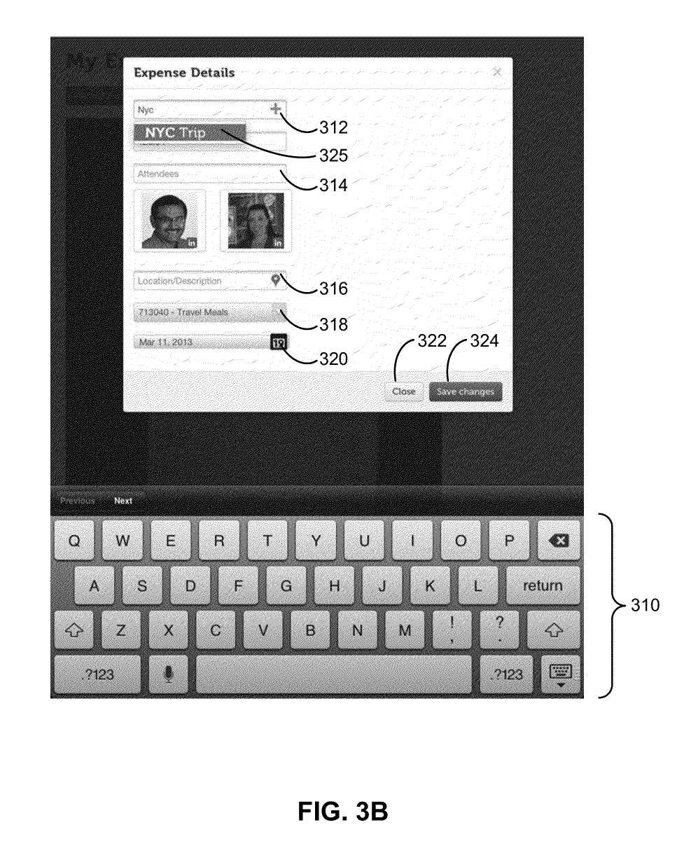

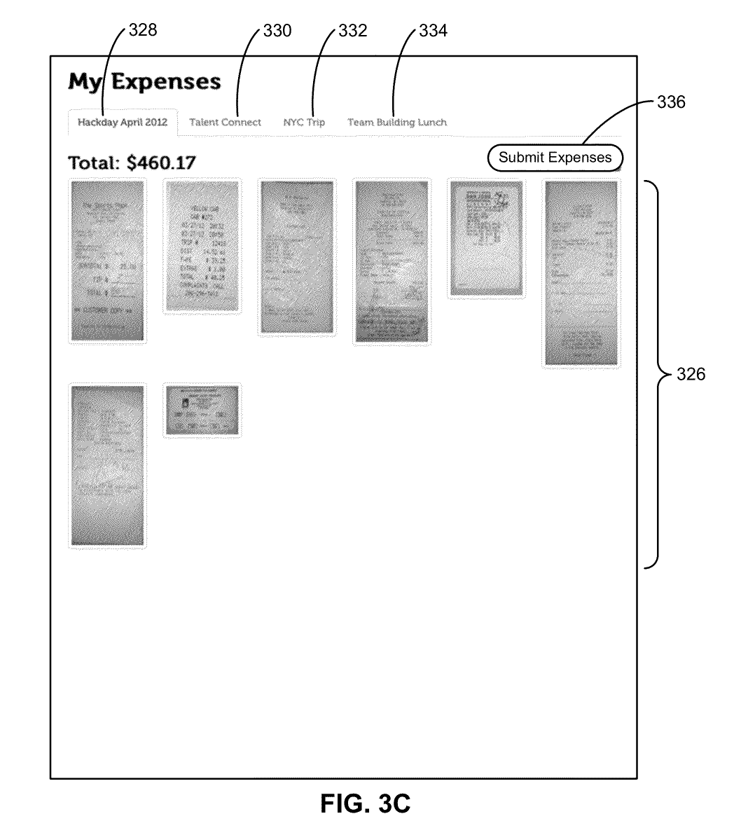

FIG. 3A shows an exemplary screenshot in accordance with the disclosed embodiments. More specifically, FIG. 3A shows a screenshot of a user interface for obtaining an image 302 of a receipt for an expense, such as user interface 234 of FIG. 2. As mentioned above, image 302 may be obtained using a built-in camera on a portable electronic device through which the user interface is provided. Alternatively, image 302 may be obtained from storage on the portable electronic device if image 302 was previously captured by the built-in camera or an external camera and saved on the storage for subsequent retrieval and use.

After image 302 is captured and/or selected for the expense, a user-interface element 308 (e.g., “Save”) may be selected to save image 302 with the expense. Another user-interface element 304 (e.g., “Manually enter data”) may be selected to enter expense data for the expense, as described in further detail below with respect to FIG. 3B. Finally, a third user-interface element 306 (e.g., “Send for transcription”) may be selected to transmit image 302 to a third-party service for transcribing information from image 302 into expense data for the expense, thus reducing the amount of work required of a user in creating an expense report containing the expense.

FIG. 3B shows an exemplary screenshot in accordance with the disclosed embodiments. More specifically, FIG. 3B shows a screenshot of a user interface for entering expense data for an expense. For example, the user interface of FIG. 3B may be shown after image 302 is selected for the expense through the user interface of FIG. 3A.

As shown in FIG. 3B, a virtual keyboard 310 and a set of user-interface elements 312-320 may be used to enter the expense data. Each user-interface element 312-320 may be selected (e.g., tapped) by a user, and expense data may be entered into the user-interface element using virtual keyboard 310, another I/O device, and/or additional user-interface elements shown to the user after the user-interface element is selected.

First, the user may enter an expense group by selecting user-interface element 312 and typing the name of the expense group using virtual keyboard 310. Moreover, the entry of the expense group into user-interface element 312 may be expedited by a field 325 (e.g., “NYC Trip”) below user-interface element 312 that suggests and/or auto-completes the entry based on previously entered information and/or information from an online professional network associated with the user, such as online professional network 222 of FIG. 2.

Next, the user may specify a set of participants using user-interface element 314 (e.g., “Attendees”). For example, the user may begin typing the name of each participant using virtual keyboard 310, and the user interface may suggest and/or auto-complete the name based on the user's connections in the online professional network. Images and/or thumbnails of participants added using user-interface element 314 may then be shown in the user interface below user-interface element 314.

The user may also provide a location and/or description of the expense using user-interface element 316 (e.g., “Location/Description”). To aid the user in completing user-interface element 316, the user interface may use location information from the portable electronic device to populate user-interface element 316 and/or provide a list of businesses in proximity to the portable electronic device for selection by the user.

The user may then select an expense type using user-interface element 318 (e.g., “713040—Travel Meals”). For example, the user may tap user-interface element 318 to access a drop-down menu of possible expense types, and then select an entry in the drop-down menu corresponding to “713040—Travel Meals.”

Finally, the user may specify a date (e.g., “Mar. 11, 2013”) associated with the expense using user-interface element 320. For example, the user may tap on user-interface element 320 to access a pop-up calendar within the user interface and select a date within the pop-up calendar. Alternatively, the user may manually enter the date into user-interface element 320 using virtual keyboard 310 and/or another I/O device.

After the user has entered expense data into user-interface elements 312-320, the user may select a user-interface element 324 (e.g., “Save changes”) to save the expense data with the expense. Conversely, the user may select a user-interface element 322 (e.g., “Close”) to exit the user interface of FIG. 3B without saving the expense data.

FIG. 3C shows an exemplary screenshot in accordance with the disclosed embodiments. More specifically, FIG. 3C shows a screenshot of a user interface for creating an expense report. For example, the user interface of FIG. 3C may be shown after a set of images of receipts for expenses and a set of expense data for the expenses are obtained through the user interfaces of FIGS. 3A-3B.

Within the user interface of FIG. 3C, a set of images 326 of expenses may be displayed to enable review of the expenses. For example, the user may select (e.g., tap) an image within the user interface to access a larger version of the image, view expense data for the corresponding expense, modify the expense data, and/or remove the expense from the expense report.

Images 326 may be associated with an expense group represented by a user-interface element 328 (e.g., “Hackday April 2012”), and a total amount (e.g., “Total: $460.17”) associated with expenses in the expense group may be shown below user-interface element 328. The user may also select user-interface element 330 (e.g., “Talent Connect”), user-interface element 332 (e.g., “NYC Trip”), and/or user-interface element 334 (e.g., “Team Building Lunch”) to access images and/or expense data associated with expense groups represented by user-interface elements 330-334 and/or submit expense reports containing the images and/or expense data.

After the user has finished reviewing images 326 and/or the associated expenses, the user may select a user-interface element 336 (e.g., “Submit Expenses”) to submit an expense report containing images 326 and the corresponding set of expense data. Images 326 and/or the expense data may then be transmitted and/or displayed to a reviewer of the expense report and organized (e.g., color-coded, sorted, etc.) based on attributes of the expense data to facilitate processing, auditing, and/or review of the expenses by the reviewer. (As mentioned above, color coding can significantly reduce human errors during the process of reviewing expense reports.)

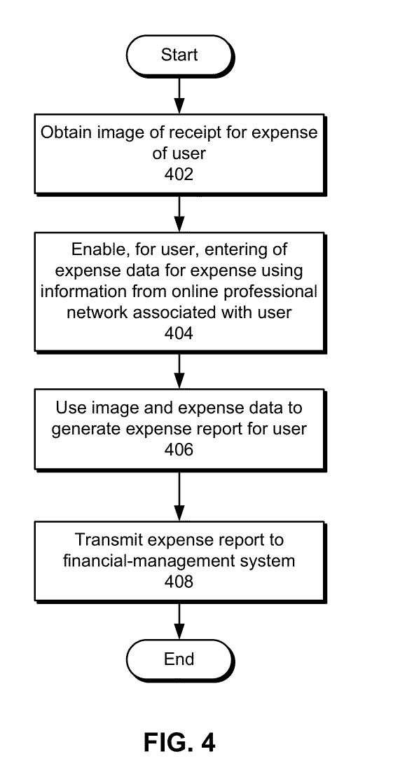

FIG. 4 shows a flowchart illustrating the process of generating an expense report in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, an image of a receipt for an expense of a user is obtained (operation 402). The image may be taken by a camera on a portable electronic device (e.g., mobile phone, tablet computer, portable media player, digital camera, etc.) of the user and/or stored on the portable electronic device. Next, entering of expense data for the expense using information from an online professional network associated with the user is enabled for the user (operation 404). For example, information from the online professional network may be used to populate and/or auto-complete user-interface elements through which the user provides the expense data. As a result, the user may provide the expense data more quickly and/or easily than if the user were required to enter the expense data in the absence of integration with and/or information from the online professional network.

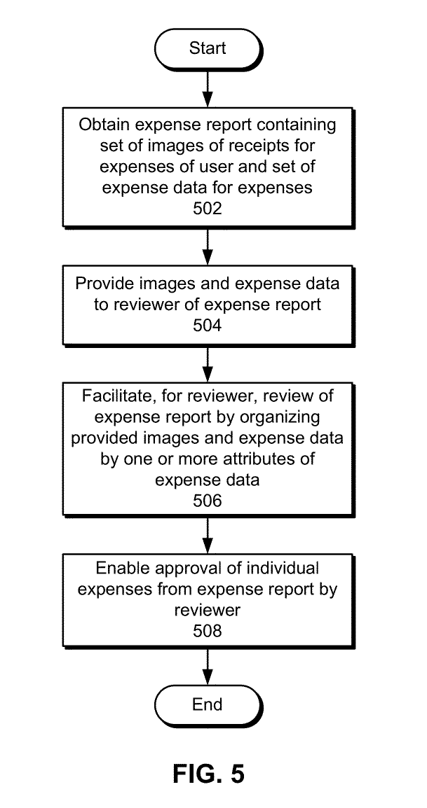

The image and expense data are used to generate an expense report for the user (operation 406), and the expense report is transmitted to a financial-management system (operation 408) for processing using the financial-management system. To generate the expense report, additional images of receipts for other expenses of the user and additional expense data for the other expenses may also be obtained, and the image and expense data may be aggregated with the additional images and additional expense data into a set of images and a set of expense data for the expense report. Review of the set of images and the set of expense data by the user may also be enabled prior to generating the expense report. Once the expense report is received at the financial-management system, expenses in the expense report may be reviewed, audited, and/or approved, as discussed in further detail below with respect to FIG. 5.

FIG. 5 shows a flowchart illustrating the process of facilitating expense management in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, an expense report containing a set of images of receipts for expenses of a user and a set of expense data for the expenses is obtained (operation 502). The expense data may include a name, an expense group, an expense type, a location, a date, an amount, and/or one or more participants. The expense data may be provided separately from the images, or one or more data elements of the expense data may be provided in metadata (e.g., EXIF data) for the images.

Next, the images and expense data are provided to a reviewer of the expense report (operation 504). For example, the reviewer may be identified using an organizational structure of the user's employer, which may be obtained from an online professional network associated with the user and/or reviewer. The images and expense data may then be displayed to the reviewer within a user interface for performing expense management.

In addition, review of the expense report is facilitated for the reviewer by organizing the provided images and expense data by one or more attributes of the expense data (operation 506). For example, the images and/or expense data may be color-coded and/or sorted by attributes such as expense type, expense group, location, date, amount, and/or participants. The reviewer may access different “views” of the images and/or expense data by specifying the attributes by which the images and/or expense data are to be sorted and/or color-coded.

Finally, approval of individual expenses from the expense report by the reviewer may be enabled (operation 508). For example, images and/or expense data for individual expenses may be displayed to the reviewer within the user interface, and approval of the expenses may be obtained through the user interface.

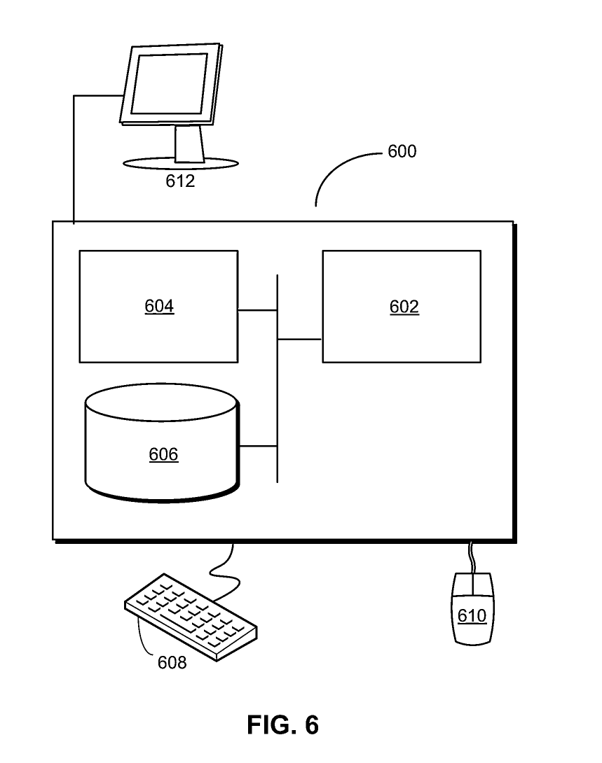

FIG. 6 shows a computer system 600 in accordance with an embodiment. Computer system 600 may correspond to an apparatus that includes a processor 602, memory 604, storage 606, and/or other components found in electronic computer systems. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, FIG. 6 provides a system for facilitating expense management. The system may include a reporting apparatus that obtains an image of a receipt for an expense of a user and enables, for the user, entering of expense data for the expense using information from an online professional network associated with the user. Next, the reporting apparatus may include the image and the expense data in an expense report comprising a set of images of receipts for expenses of the user and a set of expense data for the expenses.

The system may also include a management apparatus that provides the set of images and the set of expense data to a reviewer of the expense report and organizes the provided images and expense data by one or more attributes of the expense data. The management apparatus may further enable approval of individual expenses from the expense report by the reviewer.

In addition, one or more components of computer system 600 may be remotely located and connected to the other components over a network. Portions of the present embodiments (e.g., reporting apparatus, management apparatus, server, electronic devices, etc.) may also be located on different nodes of a distributed system that implements the embodiments. For example, the present embodiments may be implemented using a cloud computing system that facilitates the generation and/or review of expense reports for a set of remote users.

The foregoing descriptions of various embodiments have been presented only for purposes of illustration and description. They are not intended to be exhaustive or to limit the present invention to the forms disclosed.

Accordingly, many modifications and variations will be apparent to practitioners skilled in the art. Additionally, the above disclosure is not intended to limit the present invention.

1. A computer-implemented method for generating an expense report, comprising:
obtaining, at a computer system, at least an image of a receipt for an expense of a user;
obtaining, at the computer system, information comprising the user's connections from an online professional network associated with the user;
identifying participants associated with the expense using the obtained information;
enabling, for the user, entry of expense data including the participants associated with the expense, via a graphical user interface (GUI) in the computer system, using the obtained information;
organizing, using the computer system, the obtained image and expense data based on one or more attributes of the expense data to form an expense report; and
displaying the expense report via the GUI, wherein the expense report comprises the organized image and expense data.

2. The computer-implemented method of claim 1, further comprising:
transmitting the expense report to a financial-management system, wherein the expense report is processed using the financial-management system.

3. The computer-implemented method of claim 1, wherein the image is obtained using a portable electronic device of the user.

4. The computer-implemented method of claim 1, wherein the information from the online professional network is associated with at least one of:
a set of connections of the user;
an organizational structure of an employer of the user;
a calendar of the user; and
a set of businesses in proximity to the expense.

5. The computer-implemented method of claim 1, wherein using the image and the expense data to generate the expense report involves:
obtaining additional images of receipts for other expenses of the user and additional expense data for the other expenses; and
aggregating the image, the expense data, the additional images, and the additional expense data into a set of images and a set of expense data for the expense report.

6. The computer-implemented method of claim 5, wherein using the image and the expense data to generate the expense report further involves:
enabling review of the set of images and the set of expense data by the user prior to generating the expense report.

7. The computer-implemented method of claim 1, wherein the expense data comprises at least one of a name, an expense group, an expense type, a location, a date, an amount, and one or more participants.

8-18. (canceled)

19. A non-transitory computer-readable storage medium storing instructions that when executed by a computer cause the computer to perform a method for generating an expense report, the method comprising:
obtaining at least an image of a receipt for an expense of a user;
obtaining information comprising the user's connections from an online professional network associated with the user;
identifying participants associated with the expense using the obtained information;
enabling, for the user, entry of expense data including the participants associated with the expense, via a GUI, using the obtained information;
organizing, using a computer system, the obtained image and expense data based on one or more attributes of the expense data to form an expense report; and
displaying the expense report via the GUI, wherein the expense report comprises the organized image and expense data.

20. The non-transitory computer-readable storage medium of claim 19, wherein the information from the online professional network is associated with at least one of:
a set of connections of the user;
an organizational structure of an employer of the user;
a calendar of the user; and
a set of businesses in proximity to the expense.

21. The non-transitory computer-readable storage medium of claim 19, wherein using the image and the expense data to generate the expense report involves:
obtaining additional images of receipts for other expenses of the user and additional expense data for the other expenses; and
aggregating the image, the expense data, the additional images, and the additional expense data into a set of images and a set of expense data for the expense report.

22. The non-transitory computer-readable storage medium of claim 21, wherein using the image and the expense data to generate the expense report further involves:
enabling review of the set of images and the set of expense data by the user prior to generating the expense report.

23. The non-transitory computer-readable storage medium of claim 19, wherein the expense data comprises at least one of a name, an expense group, an expense type, a location, a date, an amount, and one or more participants.
